(19) United States
(12) Patent Application Publication
(10) Pub. No.: US 2005/0221762 A1
(43) Pub. Date: Oct. 6, 2005

(54) Cellular phone holster

(76) Inventor: Marcelle Greene, Temple City, CA (US)

Correspondence Address: RAYMOND Y. CHAN, 108 N. YNEZ AVE., SUITE 128, MONTEREY PARK, CA, 91754, US

(21) Appl. No.: 10/819,770

(22) Filed: Apr. 6, 2004

(51) Int. Cl. H04Q 7/20

(52) U.S. Cl. 455/66.1

(57) ABSTRACT

A cellular phone holster for carrying a cellular phone on a user's body includes a holster body and an adjustable carrying arrangement. The holster body has a top opening, a holding cavity adapted for at least a bottom portion of the cellular phone securely disposing therein through the top opening, and two styling openings formed at two sides of the holster body respectively to communicate the holding cavity with outside such that the styling openings is adapted for exposing two sides of the bottom portion of the cellular phone. The adjustable carrying arrangement provided at a rear side of the holster body for the user to carry the holster body.

### BACKGROUND OF THE PRESENT INVENTION

1. Field of Invention

The present invention relates to a holster, and more particularly to a cellular phone holster which is adapted to securely carry a cellular phone of a wide variety of sizes onto different positions of a user's body.

2. Description of Related Arts

Nowadays, most people have a cellular phone for mobile communication. A pressing problem arises as how do people carry their cellular phones safely so as to ensure that the cellular phones are well-protected, securely fastened to the user's body, and at the same time, without curtailing what might be a deliberately and sophisticatedly designed appearance.

A conventional cellular phone holder usually comprises a phone holder and a fastening device provided at a rear side thereof for fastening with, for example, a belt on the user's body. It is usually made of transparent plastic material so that the cellular phone is visible from outside through the cellular phone holder. For more enhanced protection to the cellular phone or more noble appearance of the holder, the holder may be fabricated by leather of various kinds so as to suit different application circumstances. For example, when one is attending an important conference, he/she may prefer a more elegant cellular phone holder which is made of high quality leather.

Both kinds of the above-mentioned cellular phone holders have their inherent problems. For those which are fabricated by plastic, they usually lack of elegancy and therefore unsuitable for important or formal activity. Moreover, in order to enhance a visibility to the cellular phone inside the holder, the plastic material is usually a thin one therefore lacks sufficient protection to the cellular phone.

For those which are fabricated by leather, though they may possess an adequate level of elegance, the usual embodiment is that the cellular phone is fully embedded so that there is little hope that people could see the cellular from outside, thus rendering what might be a sophisticatedly and wonderfully designed appearance of the cellular phone virtually meaningless.

Thus one can see that although cellular phones and their holders are popular, the existing products in the marketplace are far from satisfactory.

### SUMMARY OF THE PRESENT INVENTION

A main object of the present invention is to provide a cellular phone holster which is adapted to carry a cellular phone on a user's body and allow a substantial part of the cellular phone to be exposed out of the cellular phone holster.

Another object of the present invention is to provide a cellular phone holster comprising a holster body which is adapted to carry a cellular phone therein on a user's body, in which the cellular phone is conveniently accessible by a user for use thereof.

Another object of the present invention is to provide a cellular phone holster which comprises an adjustable carrying unit for attaching the holster body onto a user's body in a wide variety of different styles.

Another object of the present invention is to provide a cellular phone holster which utilizes a minimum amount of raw material for providing a secure mobile support to the cellular phone, and at the same time, allowing the appearance of the cellular phone to be exposed out of the holster.

Another object of the present invention is to provide a cellular phone holster which is light, flexible, durable and does not create any damage to the cellular phone so as to maximize its applicability.

Accordingly, in order to accomplish the above objects, the present invention provides a cellular phone holster, comprising:
a holster body having a top opening, a holding cavity adapted for at least a bottom portion of the cellular phone securely disposing therein through the top opening, and two styling openings formed at two sides of the holster body respectively to communicate the holding cavity with outside such that the styling openings is adapted for exposing two sides of the bottom portion of the cellular phone so as to enhance an aesthetic appearance of the cellular phone to outside while the cellular phone is allowed to be accessed through the accessing openings; and
an adjustable carrying arrangement provided at a rear side of the holster body for the user to carry the holster body.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a cellular phone holster according to a preferred embodiment of the present invention.

FIG. 2 is a front view of the cellular phone holster according to the above preferred embodiment of the present invention.

FIG. 3 is a sectional side view of the cellular phone holster according to the above preferred embodiment of the present invention.

FIG. 4 is a partially exploded perspective view of the cellular phone holster according to the above preferred embodiment of the present invention.

FIG. 5A to FIG. 5C are schematic diagrams of the cellular phone holster for use in conjunction with a cellular phone on different positions of the user's body according to the above preferred embodiment of the present invention.

### DETAILED DESCRIPTION OF THE PREFERRED EMBODIMENT

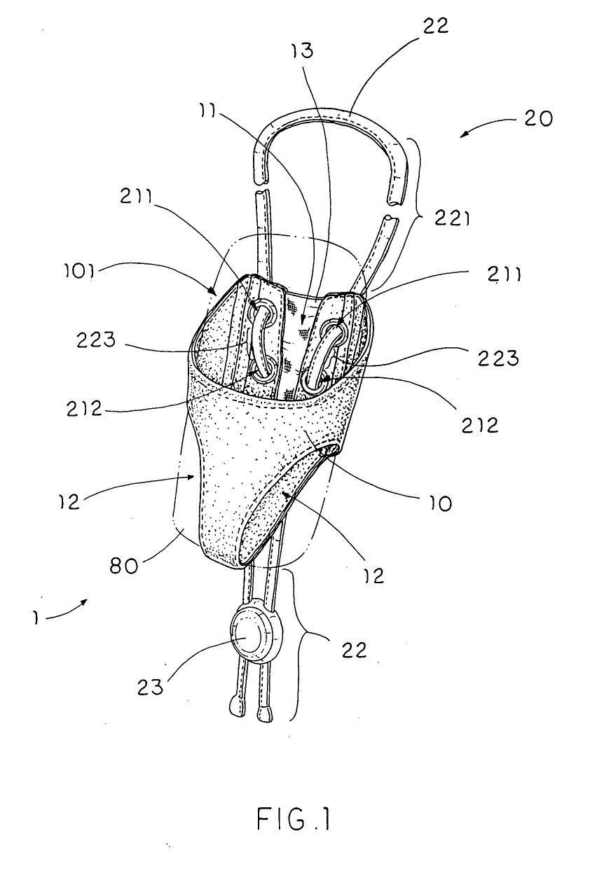

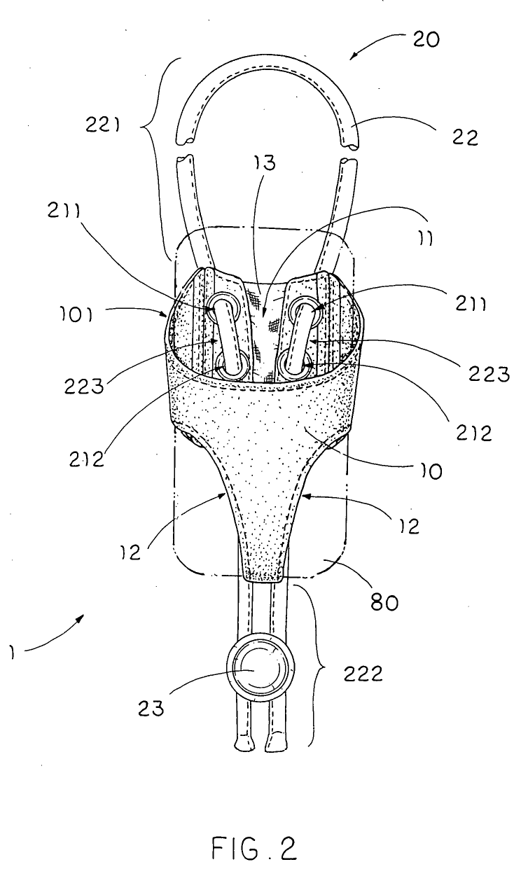

Referring to FIG. 1 to FIG. 2 of the drawings, a cellular phone holster 1 for carrying a cellular phone 80 on a user's body is illustrated, in which the cellular phone holster 1 comprises a holster body 10 and an adjustable carrying arrangement 20.

The holster body 10 has a top opening 101, a holding cavity 11 adapted for at least a bottom portion of the cellular phone 80 securely disposing therein through the top opening 101, and two styling openings 12 formed at two sides of the holster body 10 respectively in such a manner that the styling openings 12 are adapted for exposing two sides of the bottom portion of the cellular phone 80 so as to enhance an aesthetic appearance of the cellular phone 80 to outside while it is allowed to be conveniently accessed through the accessing openings 12.

The adjustable carrying arrangement 20 is provided at a rear side of the holster body 10 for the user to carry the holster body 10 on his/her body.

According to the preferred embodiment, the holster body 10 is made of leather which is flexible and durable for normal operation in carrying the cellular phone 80 on the user's body.

Referring to FIG. 1 of the drawings, the two styling openings 12 of the holster body 10 are formed at two bottom corner portions thereof and communicating the holding cavity 11 to an exterior of the holster body 10 such that a bottom portion of the holster 10 forms as a bottom bridge between the two styling openings 12 for supporting the bottom side of the cellular phone 80 at a mid-portion thereof. In other words, the holster body 10 forms a three-point support for the cellular phone 80 which is to be disposed in the holding cavity 11, as shown in FIG. 2 of the drawings. As a result, the two side bottom corner portions of the cellular phone 80 are arranged to be exposed out of the holster body 10 through the two styling openings 12 respectively. In other words, a substantial part of the aesthetical appearance of the cellular phone 80 can be showed out via the two styling openings 12 so as to maximize an exposed area of the cellular phone 80. Moreover, a user of the present invention may be able to access the cellular phone via the two styling openings 12 without needing to detach the phone from the holster body 10.

According to the preferred embodiment of the present invention, a front top edge of the holster body 10 is positioned below a rear top edge thereof to form the top opening 101 in an inclined manner for allowing an upper front portion of the cellular phone 80 to be exposed to outside while the bottom portion of the cellular phone 80 is securely held within said holding cavity 11.

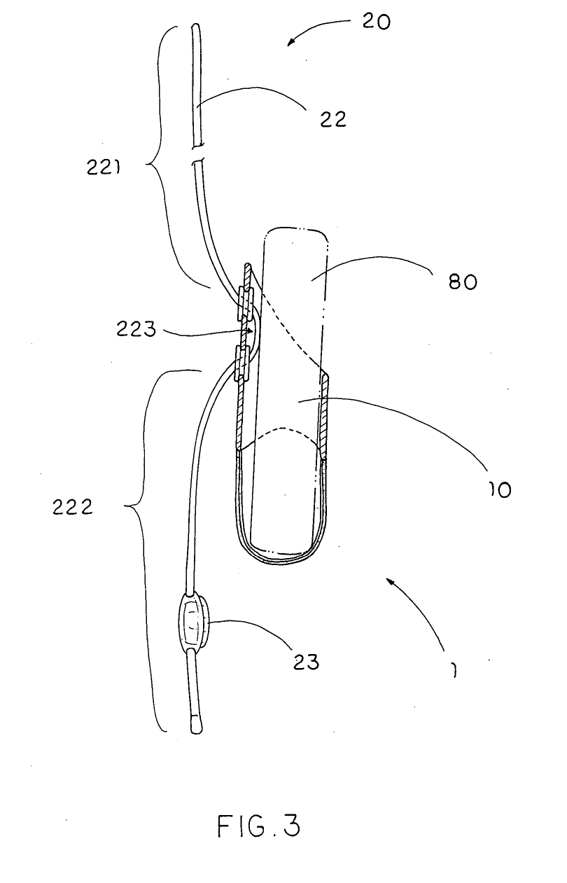

Referring to FIG. 2 to FIG. 3 of the drawings, the adjustable carrying arrangement 20 further contains two pairs of upper and lower guiding holes 211, 212 spacedly formed on the rear side of the holster body 10, and comprises a carrying strap 22 slidably mounted on the rear side of the holster body 10 through the two pairs of guiding holes 211, 212 to define a carrying loop portion 221 which is extended rearwardly from the holster body 10 for encircling the body of the user so as to carry the holster body 10 on the user.

Each of the end portions 222 of the carrying strap 22 are slidably passed through the upper guiding holes 211 from behind into the holding cavity 11 and back to the rear side of the holster body 10 through the lower guiding holes 212 respectively such that the two end portions 222 of the carrying strap 22 are positioned behind the holster body 10.

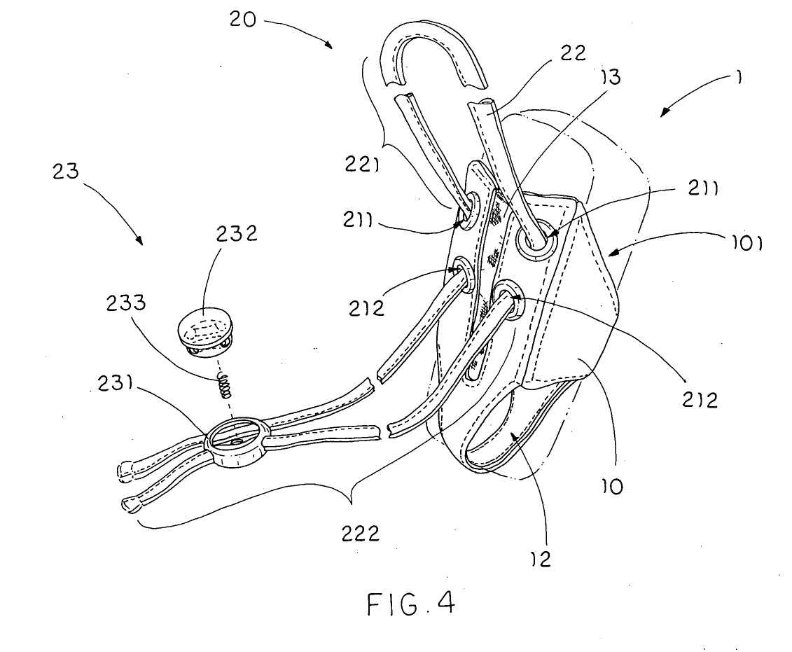

Accordingly, referring to FIG. 3 to FIG. 4 of the drawings, the carrying strap 22 further has two cushioning portions 223 defining between the end portions 222 and the carrying loop portion 221, wherein each of the cushioning portions 223 is formed within the holding cavity 11 between the respective upper and lower guiding holes 211, 212 for slightly pushing at a rear side of the cellular phone 80 so as to prevent the cellular phone 80 from directly scratching on a back wall of said holding cavity 11. In other words, by sliding the holster body 10 along the carrying strap 22, a length of the carrying loop portion 221 and the two end portions 222 can be selectively adjusted so as to optimize a length of the loop portion for detachably fastening the holster holder 10 onto different parts of the user's body.

Referring to FIG. 4 of the drawings, the adjustable carrying arrangement 20 further comprises means for selectively adjusting a length of the carrying loop portion of the carrying strap 22.

The adjusting means comprises an adjustable connector 23 slidably affixed at two end portions 221 of the carrying strap 22 for blocking a sliding movement thereof so as to retain the carrying strap 22 in position for selectively keeping the length of the carrying loop portion 221 and the two ends portion 222 substantially constant.

Specifically, the adjustable connector 23 comprises an adjusting slider 231 which the two end portions 222 of the carrying strap 22 are arranged to pass through in a slidably movable manner, and a block actuator 232 movably mounted on the adjusting slider 231 between a locked position and a releasing position, wherein in the locked position, the block actuator 232 is pushed to protrude from the adjusting slider 231 so as to bias against the two end portions 222 of the carrying strap 22 for fictionally restricting a sliding movement of the carrying strap 22 with respect to the holster holder 10, wherein in the releasing position, the block actuator 232 is adapted to release a pressing force towards the carrying strap 22 so as to allow the a sliding movement of the carrying strap 22 with respect to the holster body 11.

Furthermore, the adjustable connector 23 further comprises a resilient element 233 disposed in the adjusting slider 231 for normally pushing the block actuator 232 to be retained in the locked position. In other words, the user of the present invention may enable the sliding movement of the carrying strap 22 by pushing the block actuator 232 to the releasing position for relieving the normal biasing force exerted from the block actuator 232 to the carrying strap 22. Thereafter, the carrying strap 22 is capable of sliding with respect to the holster holder 10 for adjusting a length of the carrying loop portion 221 and the two end portions 222.

It is worth to mention that an aesthetical effect of the present invention may be enhanced by incorporating a predetermined amount of artistic works, such as a predetermine pattern of painting, on the holster body 10.

Moreover, the carrying strap 22 is embodied as having a flattened cross section such that the cushion portion 223 within the holding cavity 11 is adapted to protectively support the cellular phone 80 which is to be disposed within the holding cavity 11 at a rear side thereof. At the same time however, since the carrying strap 22 is flattened in cross section, the cushion portion 223 does not significantly interfere with the cellular phone 80 in such a manner that no significant protrusion will be observed.

As shown in FIG. 1, the holster body 10 further comprises an elastic element 13 provided at the holster body 10 for applying an elastic binding force around the top opening 101 such that a size of the top opening 101 of the holster body 10 is allowed to be self-adjusted for fittingly holding the cellular phone 80 within the holding cavity 11.

Accordingly, the elastic element 13 is an elastic binder formed at a rear panel of the holster body 10 at the top edge thereof such that the holster body 10 is capable of receiving a cellular phone 80 of different sizes into the holding cavity 11 through the top opening 101 by slightly stretching the elastic binder 13 for enlarging the top opening 101. It is worth to mention that the elastic binder 13, due to its inherent elastic nature, will normally exert an inward force for retaining the cellular phone 80 in the holding cavity 11. Preferably, the elastic element 13 is formed on the rear panel of the holster body 10 at a position between the two pairs of upper and lower guiding holes 211, 212 such that when the cellular phone 80 is disposed in the holding cavity 11, the elastic element 13 is hidden behind the cellular phone 80 so as to keep the aesthetic appearance of the holster body 10 with the cellular phone 80. Alternatively, an elastic band can be used as the elastic element to mount along the top opening 101 for applying an elastic binding force at the cellular phone 80 when the cellular phone 80 is disposed in the holding cavity 11 through the top opening 101.

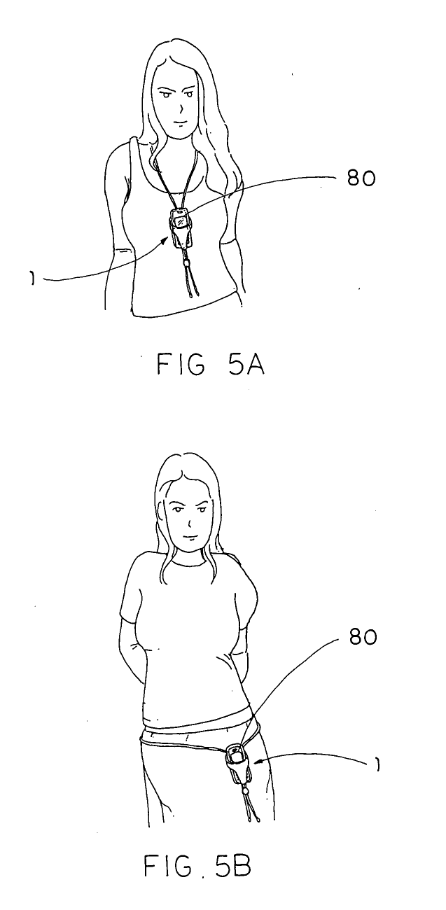

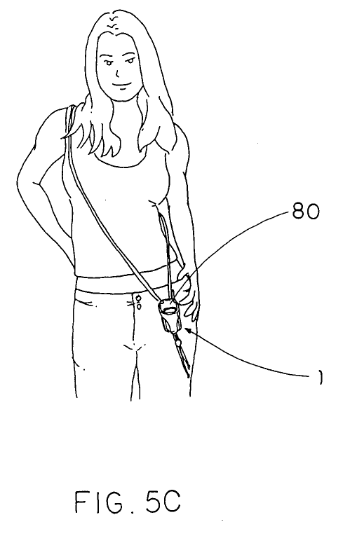

Referring to FIG. 5A to FIG. 5C of the drawings, it is important to point out that the cellular phone holster 1 may be adapted to attach on various positions on the user's body. For example, as shown in FIG. 5A of the drawings, the carrying strap 22 may be worn on the user's neck for convenient wearing and detaching. Alternatively, the holster body 10 may be inclinedly hang on the user's shoulder by the carrying strap 22, as shown in FIG. 5B of the drawings. Finally, but not exhaustively, the carrying strap 22 may be mounted on the user's hip for a fairly prolonged period of time, as shown in FIG. 5C of the drawings. In short, by adjusting a length of the carrying loop portion 221 of the carrying strap 22, the user is able to adjust a suitable length thereof for attaching the holster body 10 onto a particular part of his/her body.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A cellular phone holster for carrying a cellular phone on a user's body, comprising:
a holster body having a top opening, a holding cavity adapted for at least a bottom portion of said cellular phone securely disposing therein through said top opening, and two styling openings formed at two sides of said holster body respectively to communicate said holding cavity with outside such that said styling openings is adapted for exposing two sides of said bottom portion of said cellular phone so as to enhance an aesthetic appearance of said cellular phone to outside while said cellular phone is allowed to be accessed through said accessing openings; and
an adjustable carrying arrangement provided at a rear side of said holster body for said user to carry said holster body.

2. The cellular phone holster, as recited in claim 1, wherein said two styling openings are formed at two bottom corner portions of said holster body to communicate said holding cavity to outside so as to form a three-point support for securely holding said cellular phone in said holding cavity, in such a manner that said two styling openings are adapted for respectively allowing two bottom corner portions of said cellular phone to be exposed to outside so as to maximize an exposed area of said cellular phone.

3. The cellular phone holster, as recited in claim 1, wherein a front top edge of said holster body is positioned below a rear top edge thereof to form said top opening in an inclined manner for allowing an upper front portion of said cellular phone to be exposed to outside while said bottom portion of said cellular phone is securely held within said holding cavity.

4. The cellular phone holster, as recited in claim 2, wherein a front top edge of said holster body is positioned below a rear top edge thereof to form said top opening in an inclined manner for allowing an upper front portion of said cellular phone to be exposed to outside while said bottom portion of said cellular phone is securely held within said holding cavity.

5. The cellular phone holster, as recited in claim 1, wherein said adjustable carrying arrangement comprises a carrying strap having two end portions slidably mounted at said rear side of said holster body to define a carrying loop portion for encircling said body of said user so as to carry said holster body on said user.

6. The cellular phone holster, as recited in claim 2, wherein said adjustable carrying arrangement comprises a carrying strap having two end portions slidably mounted at said rear side of said holster body to define a carrying loop portion for encircling said body of said user so as to carry said holster body on said user.

7. The cellular phone holster, as recited in claim 4, wherein said adjustable carrying arrangement comprises a carrying strap having two end portions slidably mounted at said rear side of said holster body to define a carrying loop portion for encircling said body of said user so as to carry said holster body on said user.

8. The cellular phone holster, as recited in claim 5, wherein said adjustable carrying arrangement further contains two pairs of upper and lower guiding holes spacedly formed on said rear side of said holster body, wherein said end portions of said carrying strap are slidably passed through said upper guiding holes from behind into said holding cavity and back to said rear side of said holster body through said lower guiding holes respectively such that said two end portions of said carrying strap are positioned behind said holster body.

9. The cellular phone holster, as recited in claim 6, wherein said adjustable carrying arrangement further contains two pairs of upper and lower guiding holes spacedly formed on said rear side of said holster body, wherein said end portions of said carrying strap are slidably passed through said upper guiding holes from behind into said holding cavity and back to said rear side of said holster body through said lower guiding holes respectively such that said two end portions of said carrying strap are positioned behind said holster body.

10. The cellular phone holster, as recited in claim 7, wherein said adjustable carrying arrangement further contains two pairs of upper and lower guiding holes spacedly formed on said rear side of said holster body, wherein said end portions of said carrying strap are slidably passed through said upper guiding holes from behind into said holding cavity and back to said rear side of said holster body through said lower guiding holes respectively such that said two end portions of said carrying strap are positioned behind said holster body.

11. The cellular phone holster, as recited in claim 8, wherein said carrying strap further has two cushioning portions defining between said end portions and said carrying loop portion, wherein each of said cushioning portions is formed within said holding cavity between said respective upper and lower guiding holes for slightly pushing at a rear side of said cellular phone so as to prevent said cellular phone from directly scratching on a back wall of said holding cavity.

12. The cellular phone holster, as recited in claim 9, wherein said carrying strap further has two cushioning portions defining between said end portions and said carrying loop portion, wherein each of said cushioning portions is formed within said holding cavity between said respective upper and lower guiding holes for slightly pushing at a rear side of said cellular phone so as to prevent said cellular phone from directly scratching on a back wall of said holding cavity.

13. The cellular phone holster, as recited in claim 10, wherein said carrying strap further has two cushioning portions defining between said end portions and said carrying loop portion, wherein each of said cushioning portions is formed within said holding cavity between said respective upper and lower guiding holes for slightly pushing at a rear side of said cellular phone so as to prevent said cellular phone from directly scratching on a back wall of said holding cavity.

14. The cellular phone holster, as recited in claim 7, wherein said adjustable carrying arrangement further comprises means for selectively adjusting a length of said carrying loop portion of said carrying strap.

15. The cellular phone holster, as recited in claim 10, wherein said adjustable carrying arrangement further comprises means for selectively adjusting a length of said carrying loop portion of said carrying strap.

16. The cellular phone holster, as recited in claim 13, wherein said adjustable carrying arrangement further comprises means for selectively adjusting a length of said carrying loop portion of said carrying strap.

17. The cellular phone holster, as recited in claim 1, wherein said holster body further comprises an elastic element provided thereon for applying an elastic binding force around said top opening such that a size of said top opening of said holster is allowed to be self-adjusted for fittingly holding said cellular phone within said holding cavity.

18. The cellular phone holster, as recited in claim 4, wherein said holster body further comprises an elastic element provided thereon for applying an elastic binding force around said top opening such that a size of said top opening of said holster is allowed to be self-adjusted for fittingly holding said cellular phone within said holding cavity.

19. The cellular phone holster, as recited in claim 10, wherein said holster body further comprises an elastic element provided thereon for applying an elastic binding force around said top opening such that a size of said top opening of said holster is allowed to be self-adjusted for fittingly holding said cellular phone within said holding cavity.

20. The cellular phone holster, as recited in claim 16, wherein said holster body further comprises an elastic element provided thereon for applying an elastic binding force around said top opening such that a size of said top opening of said holster is allowed to be self-adjusted for fittingly holding said cellular phone within said holding cavity.
